(19) United States
(12) Patent Application Publication
(10) Pub. No.: US 2005/0273807 A1
(43) Pub. Date: Dec. 8, 2005

(54) Audiovisual works and methods relating to creating, transmitting and/or displaying versions thereof

(76) Inventor: Nicholas J. Nissing, St. Charles, MO (US)

Correspondence Address: HARNESS, DICKEY, & PIERCE, P.L.C, 7700 BONHOMME, STE 400, ST. LOUIS, MO, 63105, US

(21) Appl. No.: 10/846,048

(22) Filed: May 14, 2004

(51) Int. Cl. H04N 7/025; H04N 7/10

(52) U.S. Cl. 725/32; 725/34; 725/35

(57) ABSTRACT

Audiovisual works and methods related to creating, transmitting and/or displaying versions thereof. In a preferred implementation, a method generally includes providing information about at least two different versions of an audiovisual work. Each version can include at least one segment of audiovisual material in common with the other versions, and at least one segment of audiovisual material unique from the other versions. This method can also include displaying to each audience member the version of the audiovisual work that such audience member selects based upon the information provided.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise the copyright owner reserves all copyright rights whatsoever.

### FIELD

The present invention relates generally to audiovisual works, such as television programs, cinematic movies, video programs, and the like. More particularly (but not exclusively), the present invention relates to creating, transmitting and/or displaying versions of an audiovisual work in a manner that enables market segmentation and/or differentiating distribution thereof.

### BACKGROUND

Advertisers are generally interested in reaching only certain segments of the viewing population, such as viewers of a particular gender, age bracket, income level, backgrounds, interests, combinations thereof, etc. Therefore, the ability of a content provider to attract a particular segment of the viewing population can be important in creating a reliable viewer base for advertisers.

For example, certain television programs, like cooking and gardening shows, generally attract a predictable and narrow segment of the marketplace. This can be a significant benefit to advertisers that are willing to pay a higher fee per viewer than that which they would pay for a more general interest program, like a television sitcom.

But developing a myriad of television shows, movies, or other audiovisual works for each particular market segment can be especially expensive and also require tremendous creative talent to deliver so many high quality products. Indeed, production costs for cinematic movies can sometimes exceed one hundred million dollars even though such movies usually only cater to small portions of the general population's interests.

In addition, viewer popularity for a particular audiovisual work is often based at least partially on interviewer interactions, discussions, and comments (sometimes referred to as the “buzz”). This type of response is commonly observed with audiovisual works like reality television shows where viewers have been known to frequently discuss who should have won or lost oftentimes long after the show has ended. Viewer interaction can be encouraged by creating at least some level of user interaction, such as with viewer voting. Many content providers believe that the more viewer interaction that exists for a particular program, the more popular that program will become.

### SUMMARY

The present invention relates to audiovisual works and methods for creating, transmitting and/or displaying versions thereof. In a preferred implementation, a method generally includes providing information about at least two different versions of an audiovisual work. Each version can include at least one segment of audiovisual material in common with the other versions, and at least one segment of audiovisual material unique from the other versions. This method can also include displaying to each audience member the version of the audiovisual work that such audience member selects based upon the information provided.

Further areas of applicability of the present invention will become apparent from the detailed description provided hereinafter. It should be understood that the detailed description and specific examples below, while indicating exemplary embodiments of the invention, are intended for purposes of illustration only and are not intended to limit the scope of the invention.

### BRIEF DESCRIPTION OF THE DRAWINGS

The present invention will be more fully understood from the detailed description and the accompanying drawings, wherein:

FIG. 1 is an exemplary bar graph representing a simultaneous transmission of three exemplary programs each including unique segments (represented by un-shaded regions) and shared segment A (shown simultaneously transmitted) but wherein only two programs include shared segment B (shown distributed in time) in accordance with the principles of the invention;

FIG. 2 is an exemplary bar graph representing an overlapping transmission of two exemplary programs each including unique segments (represented by un-shaded regions), a similar segment C (shown simultaneously transmitted), and a shared segment D (shown distributed in time) in accordance with the principles of the invention;

FIG. 3 is an exemplary bar graph representing a non-overlapping transmission of two exemplary programs each including unique segments (represented by un-shaded regions) and a shared segment E (shown distributed in time) in accordance with the principles of the invention;

FIG. 4 is an exemplary bar graph representing an overlapping transmission of two exemplary programs each including a shared segment F (shown distributed in time), and illustrating the programs being simultaneously offered for sale in accordance with the principles of the invention; and

FIG. 5 illustrates exemplary operations of a method for creating and transmitting versions of an audiovisual work according to a preferred implementation of the invention.

### DETAILED DESCRIPTION OF PREFERRED EMBODIMENTS

The following description of preferred embodiments is merely exemplary in nature and is in no way intended to limit the invention, its application, or uses.

According to one aspect, the invention provides methods related to creating, transmitting and/or displaying different versions of an audiovisual work in a manner that enables market segmentation and/or differentiating distribution (e.g., differentiating offers for sale) of the versions of the audiovisual work. Each version includes at least one segment (“shared segment” or “common segment”) of audiovisual material in common with the other versions. Each version also includes at least one segment (“unique segment”) of audiovisual material unique from the other versions. It is understood that while each segment may correspond to scene changes within its corresponding version of the audiovisual work, such is not required as a segment can also be longer or shorter than a scene.

Unless described otherwise, for the purpose of the following description, “similar segment” generally refers to and includes a segment that shares content with another segment but which also includes at least some content variation. For example, similar segments can share content but present that content from different perspectives, such as male and female perspectives, young and mature perspectives, culturally diverse perspectives, different ethnical perspectives, different sociological perspectives, different anthropological perspectives, law enforcement and criminal perspectives, etc. By way of example, a segment in which an argument occurs between and man and a woman may be shown from the man's perspective in a first segment but be shown from the woman's perspective in another segment. Thus, these two segments can be referred to as similar segments because they share content but that content is shown from different perspectives. In this respect, a similar segment might also be referred to as a unique segment.

Various implementations of the invention are applicable to a wide range of audiovisual works. By way of example only, exemplary audiovisual works can include cinematic films, video programs, silent films, fictional programs that include artificially manufactured content, television programs (e.g., sitcoms, dramas, fictional movies, recurring television programs, game shows, etc.), and the like.

Unless described otherwise, for the purpose of the following description, the terms “common segment”, “similar segment”, and “unique segment” do not refer to or include the extraneous material (e.g., commercials, etc.) that can be added to and/or displayed in connection with a version of an audiovisual work. That is, even though an audiovisual work or the display thereof may include extraneous additions (e.g., sneak previews or trailers of upcoming movies displayed at a theater, television commercials, etc.), such extraneous additions should not be considered as a common, similar, or unique segments as those terms are used herein.

In a preferred implementation, the invention provides a method of displaying an audiovisual work on a subject to an audience comprised of subset audiences with different interests. The method can include providing information about at least two different versions of the audiovisual work on the subject. Each version includes at least one segment of audiovisual material in common with the other versions, and at least one segment of audiovisual material unique from the other versions. This method can also include displaying to each audience member the version of the audiovisual work that such audience member selects based upon the information provided. For example, at least one segment of audiovisual material in common with all versions can be displayed simultaneously to all audience members. This method can further include transmitting the common segment(s) to all audience members, and transmitting each unique segment based upon the information provided. This method can also include displaying at least one version of the audiovisual work to a general public audience, for example, at a movie theater or on network broadcast television. By way of example, one or more versions of the audiovisual work can be displayed at various times and/or at numerous locations within a twenty four period such that the total viewing audience within that twenty four hour period is about one thousand or more audience members, ten thousand or more audience members, one hundred thousand or more audience members, etc. Displaying multiple versions of an audiovisual work to mass audiences should provide sufficient interviewer interaction necessary for “buzz” marketing techniques that increases consumer demand and provide opportunities for market segmentation to large groups of consumers.

Various implementations advantageously enable versions of an audiovisual work to be incorporated into a differentiating distribution or offer for sale. A “differentiating offer for sale” generally refers to the process in which potential consumers/viewers are provided with information about different versions of an audiovisual work. For example, potential consumers/viewers can be provided with various types of information such as information about unique content in a particular version, information about unique content that is not in a particular version, information about the intended audience for a particular version (e.g., intended for male or female, young or mature audiences, etc.), and/or information about the intended audiences for the other versions. In this exemplary manner, potential consumers/viewers can be provided with sufficient information to effectuate market segmentation.

But it is understood that monetary compensation is not necessarily required to accept an offer for sale. For example, viewers of broadcast television provide remuneration to content providers indirectly by creating a market for advertisers. It should be further realized that there can be multiple offers for sale corresponding to a variety of advertising instances of which only a portion may be simultaneously offering for sale different versions of an audiovisual work.

In an exemplary scenario in which there are different versions of a movie, moviegoers can be informed of their available options (e.g., version intended for a male audience, version intended for female audience, etc.) before they enter the theater. It should be understood, however, that alternative implementations do not require a differentiating offer for sale especially if viewers/consumers intend to watch more than one version of the audiovisual work. For example, a viewer may want to view each of two different versions relating to a crime-based story wherein one version depicts the story from a criminal perspective while the other version depicts the crime from a government agency or law enforcement perspective.

Various implementations can also advantageously enable market segmentation such that versions of an audiovisual work can be directed or marketed towards different market segments. For example, one version can be targeted towards a particular market segment while another version is directed to another market segment. In some cases, there can be enough commonality between the different versions such that they can be advertised at the same time while using the same advertisement, if desired, thereby reducing advertising costs. By way of example, different versions can be marketed to different corresponding market segments wherein such market segments can differ in terms of gender, age brackets, interests, races, nationalities, ethnicities, cultures, religions, wealth, among other demographics.

Any of a wide range of suitable devices and methods can be used to transmit versions of an audiovisual work, and each version need not be transmitted with the same mode of transmission. By way of example, versions of an audiovisual work can be transmitted for display by a television (e.g., network television broadcast, high-definition television broadcast, satellite television transmission, cable television transmission, etc.), for display at movie theatres, via completely digital transmissions, via other digital and/or analog means, via combinations thereof, etc.

In various implementations of the invention, transmission and/or display of two or more versions of an audiovisual work can occur at various times. By way of example only, versions of an audiovisual work can be displayed at exactly the same time such that each version starts and ends at the same time as the other versions. Or, for example, versions of an audiovisual work can be displayed within twenty-four hours of one another and/or in a manner such that the display of each version does not overlap the display of any other version. Versions can also be displayed at other suitable times such as within six hours of one another, within one hour of one another, within seven (or more) days of one another other, etc. By way of further example, at least one version of an audiovisual work can be displayed about seven or more days after that version is created, among other suitable time frames.

Various implementations can include displaying different versions of an audiovisual work in separate theaters of a facility having at least two theaters. In these implementations, moviegoers can self-select the version they want to watch by entering the appropriate theater in which that particular version will be shown. In this exemplary manner, versions of an audiovisual work can be presented for general public audiences without requiring an electronic communication from the viewer to the content provider to affect the content of the self-selected version. This, in turn, eliminates the need for the complex electronics and high bandwidth transmissions normally required for such electronic communications between viewers and content providers.

As another example, versions of an audiovisual work can be automatically displayed at different viewing stations (e.g., different theaters in a multiplex theater facility as described, etc.). In which case, viewers can self-select the version they want to watch by selecting the appropriate viewing station. This indiscriminate transmission of versions to different viewing stations enables viewer self-selection without requiring electronic communication from the viewer to affect the content of the self-selected version. This, in turn, eliminates the need for the complex electronics and high bandwidth transmissions normally required for such electronic communications between viewers and content providers.

As yet another example, versions of the audiovisual work can be transmitting on multiple channels (e.g., different television channels, at different movie theater locations, etc.) such that viewers can make a selection of a particular version of an audiovisual work by selecting the appropriate channel. Any suitable number of channels can be employed to transmit the various versions of the audiovisual work.

In still another example, various implementations can include “parallel” transmissions of one or more versions of an audiovisual work wherein a particular version is transmitted to multiple viewers using “parallel” channels (e.g., ten channels, one hundred channels, etc.). For example, in a chain of movie theatres, the same version can be shown at multiple theater locations at about the same time or at different times, as the case may be.

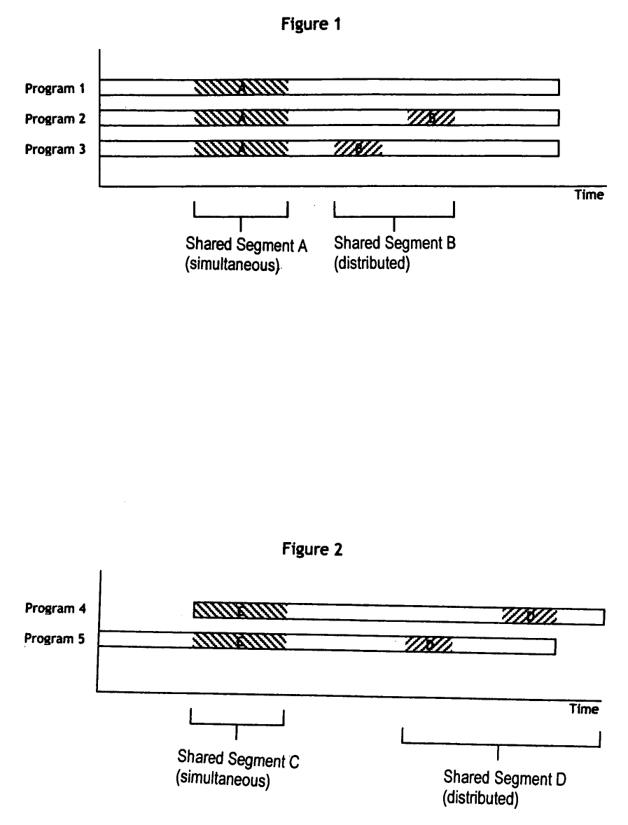

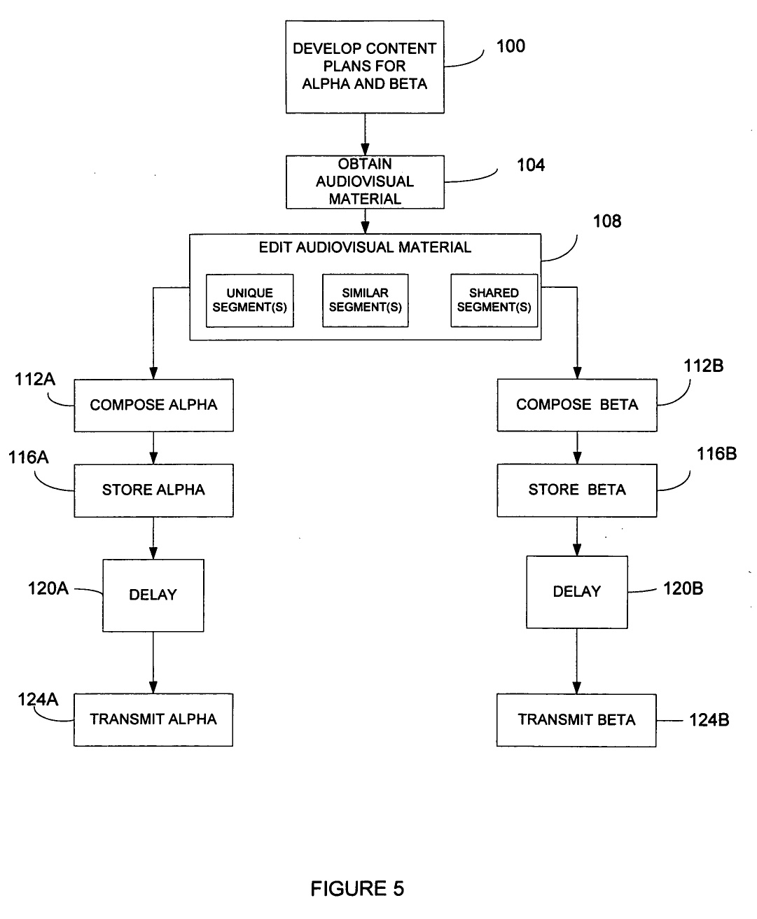

Generally, FIGS. 1 through 4 illustrate transmissions of versions of an audiovisual work to consumers/viewers. As described in further detail below, each version or program includes shared, similar and/or unique segments. FIG. 5 generally illustrates an exemplary process that can be used to create different versions of an audiovisual work.

With further reference to FIG. 1, an exemplary bar graph is shown that represents a simultaneous transmission of three programs 1, 2, and 3. Each program 1, 2, 3 starts and ends at the same time as the other programs. Each program 1, 2, 3 includes shared segment A and unique segments (represented by white or un-shaded regions). Shared segments A are transmitted simultaneously such that each segment A starts and ends at the same time as it does in the other programs.

In addition, programs 2 and 3 share another segment B. But shared segments B are distributed in time such that the starting time and ending time for segment B is different for the transmission of program 2 and the transmission of program 3.

In FIG. 2, there is shown an exemplary bar graph representing an overlapping transmission of two programs 4 and 5 such that a portion of the transmission of program 4 overlaps a portion of the transmission of program 5. Each program 4 and 5 include similar segment C, shared segment D, and unique segments (represented by white or un-shaded regions). Similar segments C are transmitted simultaneously, but shared segment D is distributed in time such that the starting time and ending time for segment D within program 4 is different than that for program 5.

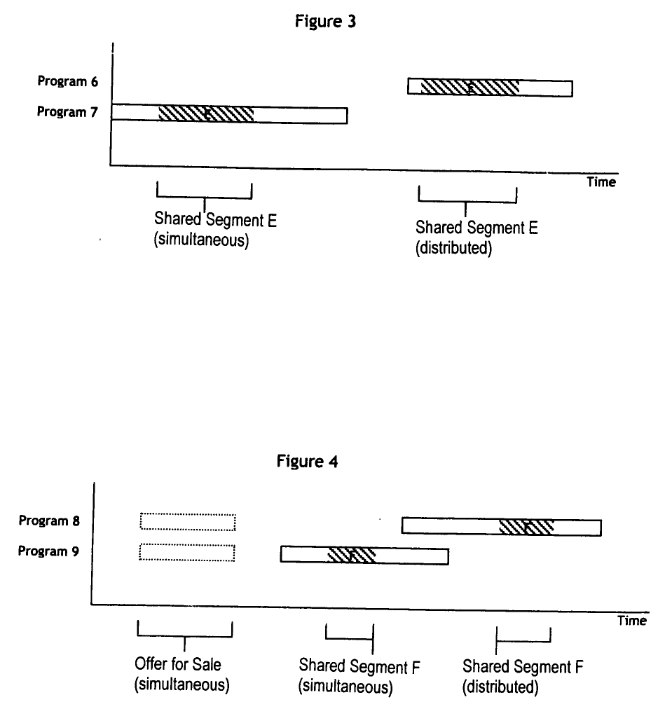

The exemplary bar graph in FIG. 3 represents a non-overlapping transmission of two programs 6 and 7 such that the transmission of program 6 ends before the transmission of program 7 begins. Programs 6 and 7 each include shared segment E which is distributed in time. Programs 6 and 7 also include unique segments which are represented by white or un-shaded regions.

FIG. 4 illustrates two programs 8 and 9 being simultaneously offered for sale before either program 8 or 9 is transmitted. The offer for sale can include providing potential consumers/viewers with notice about the availability for purchase and/or viewing one or more versions of an audiovisual work. The offer for sale can also include providing information to potential consumers/viewers about different versions of an audiovisual work. For example, potential consumers/viewers can be provided with information about unique content in a particular version, about unique content that is not in a particular version, about the intended audience for a particular version, and/or about the intended audiences for the other versions.

With further reference to FIG. 4, each program 8 and 9 includes shared segment F which is distributed in time. Programs 8 and 9 are transmitted at overlapping times such that a portion of the transmission of program 8 overlaps a portion of the transmission of program 9.

It is understood that FIGS. 1 through 4 depict programs having a rather limited number of segments for purposes of clarity and illustration and not for purposes of limitation. The arrangement and number of shared, similar and/or unique segments can vary depending on the particular application as implementations of the invention can be readily applied to programs having more or less segments. Indeed, it should be recognized that the number of segments within a particular version or program may be significantly higher (e.g., one hundred or more segments, etc.) with segments lasting various lengths from very short to very long. Additionally, segments need not be shown in the same chronological order or arrangement within multiple versions of an audiovisual work if the story dictates a different preferred order (e.g., if one version includes a flashback segment, but another version does not, etc.).

Referring now to FIG. 5, there are shown various exemplary operations for creating versions or segmented programs alpha and beta that share at least some elements of a storyline. But it should be realized that a similar diagram could be generated for any suitable number of versions or programs which are based on a same storyline.

And while FIG. 5 provides a general order in which operations can be performed, it will be appreciated that a particular program or version may progress to the next operation before a prior operation has been fully completed for the entire program. For example, obtaining audiovisual material will generally occur before editing, but editing of earlier filmed portions may begin before filming has been entirely completed for all portions of the program. Or, for example, editing can be performed concurrently with filming, or editing can be performed before all filming is completed, such as when inadequate results require additional filming. These variations do not depart from the substance of the invention and are intended to be within the scope of the invention. Therefore, such variations are not to be regarded as a departure from the spirit and scope of the invention.

As shown in FIG. 5, operation 100 includes developing a content plan for each program, Alpha and Beta. A content plan generally refers to and includes scripts, screenplays, and the like which are typically used to tangibly record and develop the content for a fictional program before filming begins. This is unlike other “live” video recordings such as news broadcasts, sporting events, among others, in which there is usually no tangible concrete recorded content plan for the “live” unscripted event for which the “live” video is being captured.

At operation 100, content plan development can include using such tools as scripts, screenplays, and storyboards. The content plans can be created so that two independent stories are developed but the stories include shared components. Depending on the particular stories being developed, the shared components can include shared actors, settings, music, props, among others.

Operation 104 includes obtaining (e.g., filming, videotaping, etc.) audiovisual material in accordance with the content plans developed at operation 100. It should be realized that reasonable deviations from the content plan are to be expected given the possibility for unexpected outcomes that may occur while obtaining audiovisual material, for additional creative input, and for revisions based on test viewings. Any of wide range variety of suitable devices and methods can be employed to obtain audiovisual material at operation 104, including but not limited to digital photography, analog photography, animation, stop-action photography, digital animation, computer generated images, combinations thereof, among other suitable means for obtaining audiovisual material.

Operation 108 includes editing audiovisual material into segments (e.g., shared segments, unique segments, similar segments) which may or may not correspond to scene changes. This audiovisual material being edited at operation 108 can include audiovisual material obtained at operation 104 and/or preexisting audiovisual material (e.g., stock footage obtained prior to development of the content plans at operation 100, etc.).

Operations 112A and 112B include assembling or composing segments into versions Alpha and Beta, respectively, such that each version includes at least one shared segment and at least one unique segment. It should be noted that assembling segments may occur during the traditional editing process. But assembly may also occur after all individual segments have been edited. In addition, traditional editing may further take place after segments have been assembled or composed into the versions or programs.

After the composition process is complete, Alpha and Beta can be stored at operations 116A and 116B, respectively. Alpha and Beta can be stored on the same or different types of storage media. Exemplary storage media on which Alpha and/or Beta can be stored include film, digital storage devices, analog storage devices, combinations thereof, and the like.

In FIG. 5, there is shown an optional period of delay 120A and 120B between when Alpha and Beta are stored and when they are transmitted. By way of example only, various implementations can include allowing seven or more days to pass between the storing and transmitting of Alpha and/or Beta.

During this period of delay 120A and 120B, either or both programs Alpha and Beta can be offered for sale. Additionally, or alternatively, programs Alpha and Beta can be offered for sale at any other appropriate time including before, after or during operation 100 (content plan development), operation 104 (obtaining audiovisual content), operation 108 (editing), operation 112 (composing), operation 116 (storing), and/or operation 124 (transmitting).

Optionally, programs Alpha and Beta can be simultaneously offered for sale. Further, programs Alpha and Beta can be incorporated into a differentiating offer for sale wherein potential consumers/viewers are provided with sufficient information about either or both programs Alpha and Beta to effectuate market segmentation as described above.

Operations 124A and 124B include transmitting for display to each audience member the respective version, Alpha or Beta, that such audience member selected. Preferably, these transmissions occur in a manner that allows a relatively large number of audience members/viewers to watch at a given time. Any of a wide range of suitable devices and methods can be used for transmitting Alpha and Beta including radio frequency broadcast, television network broadcast, high-definition television broadcast, satellite, cable, movie theatres, combinations thereof, among other digital and/or analog means, etc.

Regarding the particular content of versions of an audiovisual work, the ratio (Rₛₕ) of shared segments to unique segments may vary over a wide range. This ratio (Rₛₕ) can be calculated by summing time duration of each shared segment, and then dividing that total time duration of shared segments by the difference obtained by subtracting the total time duration of shared segments from the total time duration of all segments. This relationship can be represented by the following equation:
Rₛₕ=Tₛₕ/[Tₜₒₜₐₗ−Tₛₕ]
where:
Rₛₕ is the ratio of shared segments to unique segments;
Tₛₕ is the total time duration of shared segments; and
Tₜₒₜₐₗ is the total time duration of all segments.

In addition, the ratio (Rᵤ) of unique segments to shared segments may also vary over a wide range. This ratio (Rᵤ) can be calculated by summing time duration of each unique segment, and then dividing that total time duration of unique segments by the difference obtained by subtracting the total time duration of unique segments from the total time duration of all segments. This relationship can be represented by the following equation:
Rᵤ=Tᵤ/[Tₜₒₜₐₗ−Tᵤ]
where:
Rᵤ is the ratio of unique segments to shared segments;
Tᵤ is the total time duration of unique segments; and
Tₜₒₜₐₗ is the total time duration of all segments.

In addition, the ratio (Rₛₛ) of similar segments to the other segments (i.e., the shared segments and those unique segments which are not similar segments) may vary over a wide range. This ratio (Rₛₛ) can be calculated by summing time duration of each similar segment, and then dividing that total time duration of similar segments by the difference obtained by subtracting the total time duration of similar segments from the total time duration of all segments. This relationship can be represented by the following equation:
Rₛₛ=Tₛₛ/[Tₜₒₜₐₗ−Tₛₛ]
where:
Rₛₛ is the ratio of similar segments to the other segments;
Tₛₛ is the total time duration of similar segments; and
Tₜₒₜₐₗ is the total time duration of all segments.

Furthermore, the ratio (Rₜₛ) of the total time duration of similar and shared segments to unique segments may vary over a wide range. For purposes of calculating the ratio Rₜₛ, similar segments are treated separately from and not considered to be unique segments. This ratio (Rₜₛ) can be calculated by summing time duration of each shared segment, summing time duration of each similar segment, summing time duration of each unique segment, and then dividing the sum of the total time duration of shared and similar segments by the total time duration of unique segments. This relationship can be represented by the following equation:
Rₜₛ=(Tₛₕ+Tₛₛ)/Tᵤ
where:
Rₜₛ is the ratio of similar and shared segments to unique segments;
Tₛₕ is the total time duration of shared segments;
Tₛₛ is the total time duration of similar segments; and
Tᵤ is the total time duration of unique segments.

Finally, the ratio (Rₛᵤ) of similar segments to unique segments may also vary over a wide range. For purposes of calculating the ratio Rₛᵤ, similar segments are treated separately from and not considered to be unique segments. This ratio (Rₛᵤ) can be calculated by summing time duration of each similar segment, summing time duration of each unique segment, and then dividing the total time duration of similar segments by the total time duration of unique segments. This relationship can be represented by the following equation:
Rₛᵤ=Tₛₛ/Tᵤ
where:
Rₛᵤ is the ratio of similar segments to unique segments;
Tₛₛ is the total time duration of similar segments; and
Tᵤ is the total time duration of unique segments.

Contrary to expectations, the inventor has discovered preferred ranges for practicing implementations of this invention, more specifically, where the ratio (Rₛₕ) of shared segments to unique segments is either relatively high (e.g., preferably greater than about three, etc.) or relatively low (e.g., preferably less than about one). Preferred implementations can include an Rₛₕ greater than about five, or less than about one-half.

Using relatively high ratios Rₛₕ, Rₛₛ, Rₜₛ, Rₛᵤ (e.g., an Rₛₕ greater than about three, etc.) and a relatively low ratio Rᵤ can be especially beneficial for narrowly defined market segmentation in which segmentation criteria reflect known and distinct needs of the viewers. For example, as in the segmentation of movie viewers by age (described in Example 4 below in which Rₛₕ is 9), the majority of the versions of a movie may be the same with replacements of offensive material for the more sensitive or younger age groups.

Using relatively low ratios Rₛₕ, Rₛₛ, Rₜₛ, Rₛᵤ (e.g., Rₛₕ less than about one, etc.) and a relatively high ratio Rᵤ can be especially beneficial for less narrowly defined market segmentation. For example, and as described below in Example 2 in which Rₛₕ is about 0.11, viewers may be interested in those segments which are not included within the particular version being viewed. In such cases, the shared or similar segments can serve a marketing purpose by encouraging interviewer activity and attempts by the viewers to view more than one version using alternative means (e.g., videotaping one version for later viewing while watching another version, etc.).

Additionally, it may be advantageous for content suppliers to deliver each version via a different mode of transmission. For example, a content provided may transmit one version on broadcast network television while another version is transmitted for cable television to thereby encourage broadcast network television viewers to invest in a cable subscription package. Likewise, a similar marketing technique may also be applied to channels of a cable package which are sold for incremental prices.

Various implementations of this invention can advantageously allow realization of benefits related to market segmentation, interviewer interaction, and “buzz” marketing in a much more cost-effective manner than that which can be delivered by existing methods that rely on such costly high bandwidth transmission and complex electronic hardware that many consumers are unable to fully participate. Indeed, various implementations of the present invention can deliver these benefits while eliminating, or at least reducing, the need for broad distribution of high-technology hardware, Internet connectivity, phone connections, and/or substantial high band-width. Accordingly, various implementations of this invention can address long-felt needs of the industry of improved marketing potential, interviewer interactions, broader overall appeal, and reduced production costs.

As an aid in providing a more complete understanding, various examples are provided in which versions of an audiovisual work are created and transmitted in accordance with the principles of the invention. These examples, however, are for purposes of illustration only and not for purposes of limitation.

### EXAMPLE 1

### Gender Segmented Versions of a Movie

Content plans are developed using a base story, for example, a romantic comedy. Because many elements of a story can appeal preferentially to either the male gender or the female gender, two versions of the story are developed, namely, a version Alpha intended to appeal to the male gender, and another version Beta intended to appeal to the female gender.

After content plans have been developed, audiovisual material corresponding to the content plans is obtained, which can include using stock footage. The audiovisual material is edited into segments, and sound effects and music tracks are added.

Programs Alpha and Beta are composed from segments such that about thirty percent of program Alpha and program Beta are shared segments. For example, the shared segments can include initial scenes in which characterizations and background information is provided so that both programs include shared facts, circumstances, and characterizations. Approximately seventy percent of programs Alpha and Beta can be unique segments, some of which are also similar segments. More specifically, about twenty percent of Alpha and Beta can be unique segments which are similar (and thus considered to be similar segments as well) in that the same actions are depicted but from a different visual perspective with different sound effects and music, etc. to cater to predispositions of the intended audience. Approximately fifty percent of Alpha and Beta can be unique segments which are not also considered to be similar segments and which are distinctively directed to the intended audience. For example, the Beta program intended for a female audience may have longer romantic dialogue, emotional content, and enjoin humor at the expense of male characters.

Using the equations above, the Alpha and Beta programs each has a Rₛₕ (ratio of shared segments to unique segments) of about 0.43, a Rᵤ (ratio of unique segments to shared segments) of about 2.33, a Rₛₛ (ratio of similar segments to all other segments) of about 0.25; a Rₜₛ (ratio of similar and shared segments to unique segments) of about 1.0, and a Rₛᵤ (ratio of similar segments to unique segments) of about 0.40.

Each program Alpha and Beta can be separately stored on a film. Alternatively, Alpha and Beta may be stored on digital storage devices, analog storage devices, combinations thereof, etc.

Each program can be transmitted from a projector to a movie screen at approximately the same time. Each projector can be located in a different theater so that each audience sees only version Alpha or version Beta. While it is preferred to have simultaneous showings such that men and women can arrive together and view their respective programs at the same time, it would also be acceptable to distribute the viewings throughout the day as is a typical practice at multiplex theatres. In addition, various implementations can include, after Alpha and/or Beta has been created, then allowing a suitable amount of time (e.g., about seven or more days, etc.) to pass before transmitting or displaying Alpha and/or Beta.

With the shared segments and similar segments, the amount of filming and editing time needed to produce the two different versions Alpha and Beta is reduced. And given the similarity of the overall story portrayed by Alpha and Beta, both film versions can be advertised at the same time while using the same advertisement, if desired, thereby reducing advertising costs.

By portraying a story including content with two distinctly different perspectives each of which are embodied in a separate version, the film can be marketed towards both men and women which, in turn, will increase the possibility for “buzz” marketing and interviewer interactions. For example, men and women may discuss their perceptions of the occurrences in the similar and shared segments of the film.

### EXAMPLE 2

### Multiple Perspective Versions of a Television Show

Content plans are developed using a base story, such as a recurring television show about an organized crime syndicate. Typically, such television shows emphasize either a law enforcement perspective (e.g., “Law and Order”) or a criminal perspective (e.g., “The Sopranos”). But in a preferred implementation of this invention, two versions of the story are developed, one version Gamma from the criminal perspective, and another version Delta from the law enforcement perspective.

After content plans have been completed, audiovisual material corresponding to the content plans is obtained, which can include using stock footage. The audiovisual material is edited into segments, and sound effects and music tracks are added.

Programs Gamma and Delta are composed from the segments such that about ten percent of each program Gamma and Delta comprises shared segments. For example, the shared segments can include scenes containing criminal and FBI interactions (e.g., interrogations, shootouts, etc.) and background information such that both versions Gamma and Delta include shared facts, circumstances, and characterizations. Approximately ninety percent of programs Gamma and Delta can be unique segments. More specifically, about twenty percent of Gamma and Delta can be unique segments which are similar (and thus also considered to be similar segments) in that they establish facts but from different perspectives. And about seventy percent of Gamma and Delta can be unique segments but which are not also considered to be similar segments.

Using the equations above, Gamma and Delta each has a Rₛₕ (ratio of shared segments to unique segments) of about 0.11, a Rᵤ (ratio of unique segments to shared segments) of about 9.0, a Rₛₛ (ratio of similar segments to all other segments) of about 0.25; a Rₜₛ (ratio of similar and shared segments to unique segments) of about 0.43, and a Rₛᵤ (ratio of similar segments to unique segments) of about 0.29.

Each program Gamma and Delta can be separately stored on film, a digital storage device, an analog storage device, a combination thereof, etc.

Programs Gamma and Delta can be transmitted using different modes of transmission. In a particular example, program Gamma can be transmitted via satellite technology, and program Delta can be shown on broadcast network television relatively immediately following the end of program Gamma. In this exemplary manner, popularity of program Delta as seen on broadcast television will encourage viewers to invest in a satellite subscription service to obtain access to program Gamma. In addition, Delta and Gamma can be a recurring series such that viewers over time may gradually become more interested in program Delta, thereby increasing their desire to view program Gamma and pay for a satellite subscription service. Furthermore, various implementations can include, after Delta and/or Gamma has been created, allowing a suitable amount of time (e.g., about seven or more days, etc.) to first pass before transmitting or displaying either or both Delta and/or Gamma.

While market segmentation may be less pronounced in this particular example, the shared segments and similar segments will reduce the amount of filming and editing time needed to produce versions Delta and Gamma. And given the similarity between the overall story portrayed by Delta and Gamma, both versions could be advertised at the same time while using the same advertisement, if desired, thereby reducing advertising costs.

“Buzz” marketing and interviewer interactions should also be increased by this portrayal of a story including content with two distinctly different perspectives. For example, viewers of Gamma may discuss its content with viewers of Delta to enhance their perceptions of what they viewed in program Gamma.

### EXAMPLE 3

### Culturally Diverse Versions of a Audiovisual Work

Content plans are developed using a base story emphasizing interactions between two or more culturally or ethnically diverse groups of people. Two versions of the overall story are developed, one version Epsilon focusing on the story from an African American perspective, and another version Zeta focusing on the story from a Hispanic American perspective.

After content plans have been completed, audiovisual material corresponding to the content plans is obtained, which can include using stock footage and/or obtaining new footage via filming or videotaping. The audiovisual material is edited into segments, and sound effects and music tracks are added.

Programs Epsilon and Zeta are composed using segments such that about fifteen percent of programs Epsilon and Zeta are shared segments. For example, the shared segments can include protagonists from each culture interacting with each other. Approximately eighty-five percent of programs Epsilon and Zeta can be unique segments. More specifically, about fifteen percent of programs Epsilon and Zeta can be unique segments which are similar (and thus also considered to be similar segments) in that they that establish facts for both programs but taken from different perspectives. And about seventy percent of program Epsilon and program Zeta can be unique segments which are not also considered to be similar segments and which are directed towards interests of the intended viewing culture. For example, unique segments of Zeta may contain a significant amount of non-English dialogue, but these unique segments are not dubbed versions of segments from the other programs. Likewise, unique segments of Epsilon may contain culturally specific idioms and metaphors.

Using the equations above, Epsilon and Zeta each has a Rₛₕ (ratio of shared segments to unique segments) of about 0.18, a Rᵤ (ratio of unique segments to shared segments) of about 5.67, a Rₛₛ (ratio of similar segments to all other segments) of about 0.18; a Rₜₛ (ratio of similar and shared segments to unique segments) of about 0.43, and a Rₛᵤ (ratio of similar segments to unique segments) of about 0.21.

Each program Epsilon and Zeta can be stored on a digital storage device, an analog storage device, a combination thereof, etc.

Each program can be transmitted using radio frequency (RF) transmission typical of television broadcasts within the same 24 hour period, among other suitable transmission modes and time periods. In addition, various implementations can include, after Epsilon and/or Zeta has been created, allowing a suitable amount of time (e.g., about seven or more days, etc.) to first pass before transmitting or displaying either or both Epsilon and/or Zeta.

In this particular example, the market segmentation effect may be less pronounced than previously mentioned versions. But, as a result of the shared segments and similar segments, the amount of filming and editing time is reduced. In addition, given that the overall story portrayed is very similar in Epsilon and Zeta, both programs can be advertised at the same time while using the same advertisement, if desired, thereby reducing advertising costs. Furthermore, ethnic market segmentation will allow more focused and effective advertising.

In addition, the possibility for “buzz” marketing and interviewer interactions should be increased as a result of having a story including content portrayed from two distinctly different ethnic or cultural perspectives. For example, viewers of Epsilon may discuss its content with viewers of Zeta to enhance their perceptions thereof. In this specific case, interactions between viewers may enhance a sense of cultural awareness and appreciation for ethnically or culturally diverse perspectives. Further, this will also allow marketing efforts to be more efficiently targeted to the appropriate consumers.

### EXAMPLE 4

### Age Segmented Versions of a Movie

Content plans are developed using a base story, for example, an “action” movie. Action movies, like many other movies, may include content inappropriate for some younger audiences. Accordingly, two versions of the story are developed, one version Eta intended to appeal to a mature population and another version Theta intended to appeal to a younger segment of the population.

After content plans have been completed, audiovisual material corresponding to the content plans is obtained, which can include using stock footage and/or obtaining new footage via filming or videotaping. The audiovisual material is edited into segments, and sound effects and music tracks are added.

Programs Eta and Theta are assembled from segments such that about ninety percent of programs Eta and Theta comprise shared segments. These shared segments, for example, can include initial scenes in which characterizations and background information is provided such that both programs include shared facts, circumstances, and characterizations. Approximately ten percent of programs Eta and Theta can be unique segments which are specifically directed to the intended audience. For example, Eta (the program intended for a younger audience) can have excessive violence replaced by less intense segments in which relatively minor revisions are made remove the offensive content. In addition, editing and composing may be conducted such that the length of each version is about equal. In contrast, existing concatenation techniques simply remove portions of the program (e.g., removing offensive material from a cinematic movie broadcast on network television) and thus do not serve to broaden its appeal to other market segments (e.g., younger versus mature segments, etc.).

Using the equations above, Eta and Theta each has a Rₛₕ (ratio of shared segments to unique segments) of about 9.0, a Rᵤ (ratio of unique segments to shared segments) of about 0.1, a Rₛₛ (ratio of similar segments to all other segments) of about 0.0; a Rₜₛ (ratio of similar and shared segments to unique segments) of about 9.0, and a Rₛᵤ (ratio of similar segments to unique segments) of about 0.0.

Each program Alpha and Beta can be separately stored on film. Alternatively, Alpha and Beta may be stored on digital storage devices, analog storage devices, combinations thereof, etc.

Program Eta and Theta can be described in a differentiating offer for sale. For example, an indication that Eta is intended to appeal to a mature population and Theta is intended to appeal to a younger segment of the population can be provided on a listing at a theater and/or in printed advertisements, such as a newspaper. Thus, viewers can be made aware of their available choices for viewing either program and can then self-select based on personal demographics (e.g., age, etc.) or interests.

Each program can be transmitted from a projector to a movie screen at approximately the same time. Each projector can be located in a different theater so that each audience sees only version either Eta or Theta. While it is preferred to have simultaneous showings such that each intended audience (e.g., parents and their children, etc.) can arrive together and view their respective programs at the same time, it would also be acceptable to distribute the viewings throughout the day as is a typical practice at multiplex theatres.

As a result of the shared segments between Eta and Theta, the amount of filming and editing time is reduced compared to traditional methods used to create distinct programs. In addition, given that the overall story portrayed is very similar in Eta and Theta, both films can be advertised at the same time thereby further reducing costs and also generating more interviewer interaction due to the larger overall number of potential viewers (e.g., young and mature, etc.).

Accordingly, various implementations of this invention can advantageously increase market segmentation, broader viewer appeal, and interviewer interaction while also reducing costs associated with content creation. Various implementations can provide cost-effective ways of creating highly segmented versions of an audiovisual work wherein each version includes shared content which can increase interviewer interaction, but also includes unique content which can be used to market the particular version towards a different segment of the viewing audience than the other versions.

Various implementations can be beneficial to a wide variety of persons and entities associated with audiovisual entertainment. For example, various implementations can enable one or more of the following:
1) More efficient use of advertising dollars by advertisers;
2) Higher advertising income per viewer for content providers; and
3) Reduced costs for content generators.

The description of the invention is merely exemplary in nature and is in no way intended to limit the invention, its application, or uses. Thus, variations that do not depart from the substance of the invention are intended to be within the scope of the invention. Such variations are not to be regarded as a departure from the spirit and scope of the invention.

1. A method of displaying an audiovisual work on a subject to an audience comprised of subset audiences with different interests, the method comprising:
providing information about at least two different versions of the audiovisual work on the subject, each version including at least one segment of audiovisual material in common with the other versions, and at least one segment of audiovisual material unique from the other versions; and
substantially simultaneously displaying to each audience member the version of the audiovisual work that such audience member selects based upon the information provided.

2. The method according to claim 1 wherein at least one segment of audiovisual material in common with all versions is displayed simultaneously to all audience members.

3. The method according to claim 1 wherein substantially simultaneously displaying comprises displaying the audiovisual work at a facility having at least two separate theatres, and wherein each version of the audiovisual work is displayed in a separate theater.

4. The method according to claim 1 wherein substantially simultaneously displaying comprises transmitting each version of the audiovisual work on a different channel, and wherein each audience member makes a selection by selecting the appropriate channel.

5. The method according to claim 1 wherein providing information comprises providing information about unique content in a particular version of the audiovisual work.

6. The method according to claim 1 wherein providing information comprises providing information about unique content that is not in a particular version of the audiovisual work.

7. The method according to claim 1 wherein providing information comprises providing information about the intended audience for a particular version of the audiovisual work.

8. The method according to claim 1 wherein providing information comprises providing information about the intended audiences for the other versions of the audiovisual work.

9. The method according to claim 1 wherein substantially simultaneously displaying comprises:
transmitting at least one common segment to all audience members; and
transmitting each unique segment based upon the information provided.

10. The method according to claim 9 wherein each said transmitting comprises digitally transmitting.

11. The method according to claim 1 wherein substantially simultaneously displaying comprises displaying at least one version of the audiovisual work to a general public audience.

12. The method according to claim 1 wherein substantially simultaneously displaying comprises automatically displaying each version of the audiovisual work at a different viewing station.

13. The method according to claim 1 further comprising allowing an audience member to select a version of the audiovisual work without an electronic communication from the audience member.

14. The method according to claim 1 further comprising creating the versions of the audiovisual work by:
developing at least one content plan for the versions;
obtaining audiovisual material correlating to the content plan;
editing the audiovisual material into segments; and
assembling the segments into the versions of the audiovisual work.

15. The method according to claim 14 wherein substantially simultaneously displaying comprises displaying at least one version of the audiovisual work about seven or more days after creating said at least one version.

16. The method according to claim 14 wherein obtaining audiovisual material comprises obtaining artificially manufactured fictional content.

17. An audiovisual work produced according to the method of claim 14.

18. The method according to claim 1 further comprising marketing each version of the audiovisual work to a different market segment in accordance with unique content within the corresponding version.

19. The method according to claim 1 wherein substantially simultaneously displaying comprises transmitting at least two versions of the audiovisual work each with a different mode of transmission.

20. The method according to claim 1 wherein substantially simultaneously displaying comprises displaying at least one version of the audiovisual work to overlap at least one other version while also including at least one of a different start time and a different end time than the other version.

21. The method according to claim 1 further comprising allowing the user to select more than one version of the audiovisual work.

22. The method according to claim 1 wherein substantially simultaneously displaying comprises displaying at least one version of the audiovisual work about seven or more days after creating said at least one version.

23. The method according to claim 1 wherein substantially simultaneously displaying comprises displaying at least two versions of the audiovisual work within twenty-four hours of one another without any overlap.

24. The method according to claim 1 wherein each version comprises artificially manufactured fictional content.

25. The method according to claim 1 wherein each version comprises ratio of total time duration of audiovisual segments in common with the other versions to total time duration of audiovisual segments unique from the other versions which is greater than about three or less than about one.

26. A method of displaying two or more versions of an audiovisual work on a subject, the method comprising:
providing information about at least two different versions of the audiovisual work on the subject, each version including at least one segment of audiovisual material in common with the other versions, and at least one segment of audiovisual material unique from the other versions;
allowing an audience member to select a version of the audiovisual work based upon the information provided without an electronic communication from the audience member; and
displaying to each audience member the version of the audiovisual work that such audience member selects based upon the information provided.

27. The method according to claim 26 wherein displaying comprises transmitting at least one version of the audiovisual work for display by a television.

28. The method according to claim 26 wherein each version comprises a recurring television show including at least one audiovisual segment from a different perspective than a corresponding audiovisual segment in the other versions.

29. The method according to claim 26 wherein the subject of the audiovisual work comprises a crime, wherein at least one version comprises at least one audiovisual segment about the crime from a law enforcement perspective, and wherein at least one other version comprises a corresponding audiovisual segment about the crime from a criminal perspective.

30. The method according to claim 26 wherein displaying comprises simultaneously displaying to each audience member the version of the audiovisual work that such audience member selects based upon the information provided.

31. The method according to claim 26 wherein allowing and displaying comprises displaying the audiovisual work at a facility having at least two separate theatres, and wherein each version of the audiovisual work is displayed in a separate theater.

32. The method according to claim 26 wherein allowing and displaying comprises automatically displaying each version of the audiovisual work at a different viewing station.

33. The method according to claim 26 wherein displaying comprises displaying at least one version of the audiovisual work about seven or more days after creating said at least one version.

34. The method according to claim 26 wherein displaying comprises displaying at least two versions of the audiovisual work within twenty-four hours of one another without any overlap.

35. The method according to claim 26 wherein each version comprises artificially manufactured fictional content.

36. The method according to claim 26 wherein each version comprises ratio of total time duration of audiovisual segments in common with the other versions to total time duration of audiovisual segments unique from the other versions which is greater than about three or less than about one.

37. A method of producing two or more versions of an audiovisual work on a subject, the method comprising:
developing at least one content plan for the versions of the audiovisual work;
obtaining audiovisual material correlating to the content plan, the audiovisual material including artificially manufactured fictional content;
editing the audiovisual material into segments; and
assembling the segments into the versions of the audiovisual work such that each version includes at least one audiovisual segment common to all versions, at least one audiovisual segment unique from the other versions, at least one audiovisual segment including artificially manufactured fictional content, and a ratio of total time duration of audiovisual segments common to all versions to total time duration of audiovisual segments unique from the other versions which is greater than about three or less than about one.

38. The method according to claim 37 wherein each version of the audiovisual work has approximately the same total time duration.

39. The method according to claim 37 further comprising:
providing information about at least two different versions of the audiovisual work; and
displaying to each audience member the version of the audiovisual work that such audience member selects based upon the information provided.

40. The method according to claim 39 wherein displaying comprises simultaneously displaying to each audience member the version of the audiovisual work that such audience member selects based upon the information provided.

41. The method according to claim 37 further comprises automatically displaying each version of the audiovisual work at a different viewing station.

42. The method according to claim 37 further comprising allowing an audience member to select a version of the audiovisual work without an electronic communication from the audience member.

43. The method according to claim 37 further comprising displaying at least two versions of the audiovisual work within twenty-four hours of one another without any overlap.

44. The method according to claim 37 further comprising displaying at least one version of the audiovisual work about seven or more days after assembling the segments into said at least one version.

45. An audiovisual work produced according to the method of claim 37.
